(19) United States
(12) Patent Application Publication
(10) Pub. No.: US 2007/0002262 A1
(43) Pub. Date: Jan. 4, 2007

(54) Liquid crystal display panel

(76) Inventor: Shinichi Kawabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/476,750

(22) Filed: Jun. 29, 2006

(30) Foreign Application Priority Data
Jun. 29, 2005 (JP) JP 2005-189561

(51) Int. Cl. G02F 1/1339

(52) U.S. Cl. 349/155

(57) ABSTRACT

The present invention provides a liquid crystal display panel comprising a pair of substrates overlapped with and fixed to each other, and a liquid crystal layer interposed between the pair of substrates, wherein first spacers and second spacers being smaller in compressive elasticity modulus than the first spacers are utilized as spacers disposed and defining a gap between the pair of substrates, the second spacers are larger in a diameter than the first spacers, and the first spacers and the second spacers are arranged in non-display areas each located between pixel portions of the liquid crystal display panel (to separate a pair of the pixel portions adjacent to each other), respectively. The liquid crystal display panel according to the present invention thus configured indicates a higher tolerability against an external force applied thereto, and makes manufacturing margin thereof so wider as to mass-produce non-defective products easily.

The present application claims priority from Japanese application JP 2005-189561 filed on Jun. 29, 2005, the content of which is hereby incorporated by reference into this application.

### BACKGROUND OF THE INVENTION

1. Field of the Invention

The present invention relates to a liquid crystal display panel, and more specifically, to a liquid crystal display panel equipped with a structure that sets a spacing between a pair of substrates to a predetermined gap.

2. Description of the Related Art

The liquid crystal display is widely used as display devices of various kinds of monitors or television sets. The liquid crystal display is constructed by integrating a backlight to a liquid crystal display panel. FIG. 6 is an explanatory diagram of a structure of the conventional liquid crystal display panel using bead spacers. Moreover, FIG. 7 is an explanatory diagram of a structure of the conventional liquid crystal display panel using columnar spacers. In FIGS. 6A-7B, FIGS. 6A and 7A are perspective views showing internal structures and FIGS. 6B and 7B are sectional views of the liquid crystal display panels taken along A-A′ lines, respectively.

As shown in FIGS. 6A-7B, a liquid crystal display panel 9 is constructed, as a representative example, by sticking a TFT (Thin Film Transistor) substrate 1a on which thin film transistors (TFT's) are formed and a CF (Color Filter) substrate 1b on which filters of red, green, and blue colors 14R, 14G, and 14B are formed, to each other with a layer of liquid crystal 5 being interposed (sandwiched) therebetween. The pair of substrates 1a, 1b are stuck and fixed with a sealant (not shown in figures) formed on the circumferences of the respective substrates, and the liquid crystal is sealed into a region surrounded by these substrates 1a, 1b and the sealants. In the description below, each of the red filter 14R, the green filter 14G, and the blue filter 14B formed on the CF substrate is called a pixel portion 14. A reference numeral 11 denotes a TFT layer (thin film transistors, pixel electrodes, protective coat, alignment films, etc.), and 12 denotes a resign layer (a leveling film, an alignment film, etc. including the counter electrodes in the liquid display panel, such as of the TN method).

In the liquid crystal display panel 9, a gap 10 (hereinafter, also referred to as cell gap) between the two substrates 1a, 1b into which this liquid crystal 5 is sealed is an important element that determines display quality. Especially, what are important are the absolute dimension of this cell gap 10 and uniformity of the cell gap 10 over the whole surface of the display area of the liquid crystal display panel 9. Therefore, in the liquid crystal display panel 9 of such a structure, in order to keep the gap of the two substrates constant, it is common that a spacer 3 made up of a spherical transparent particle made of glass or synthetic resign whose grain size is uniform, as shown in FIGS. 6A, 6B, are dispersed (e.g. sprayed) between the two substrates, and used.

However, in the liquid crystal display panel by the conventional method of dispersing the bead spacers 3 on the substrate and using them, an assembly work is done after dispersing the bead spacers 3 on one of the substrates (for example, the CF substrate 1b). Because of this assembly, the bead spacers may spill off the substrate at the time of manufacture, which brings about contamination in a production line and becomes a cause of defective products. Moreover, in the liquid crystal display panel whose assembly is completed, if the bead spacers are included in display pixels along with the liquid crystal, the bead spacers displace the liquid crystal; accordingly, deflection of light does not occur in this portion, causing display defect. For example, when the liquid crystal display panel using transparent particles as the bead spacer is set in a black display (e.g. normally black operation), only the bead spacer portions become bright spots.

Moreover, if the bead spacers are mixed in liquid crystal, they disturb arrangement of the liquid crystal molecules near the bead spacers, which generates light leakage in portions where the arrangement is disturbed. This phenomenon leads to occurrence of a problem that the contrast of the liquid crystal display panel is lowered and a detrimental influence is exerted on the display quality. In order to circumvent this problem, as shown in FIG. 7, there was proposed a method in which columnar spacers 4 (hereinafter referred to as photo-spacers) in non-display areas 15 (shading layer portions, which is hereinafter referred to as the BM (Balk Matrix) portions) that separated a plurality of pixel portions 14 between the pixel portions on the CF substrate 1b, as shown in FIG. 7, and is used.

Generally, this photo-spacer 4 is formed as follows. First, photosensitive resin that will act as a spacer is coated on the principal plane of the substrate by a spin coating method, a slit coating method, or printing so that it will be of a predetermined thickness. Then, using a photomask that makes a portion of the spacer take the form of a convex on the substrate, the photosensitive resin is exposed using an exposure light source through the photomask. Subsequently, the photosensitive resin is subjected to a developing process, the photosensitive resin coated on any portion that is not intended to act as the spacer is removed, developer adhered to the substrate is washed away, and the substrate is dried to form convex-shaped spacers (photo-spacers) on the substrate.

Since the photo-spacer formed by such a method can be arranged in arbitrary positions in the BM portion 15 located between pixel portions that does not affect the display quality, the method can prevent lowering of the display quality caused by light leakage from the photo-spacer portions that have hitherto been a problem in terms of the bead spacer. Moreover, from the same reason, there starts to be examined a technique of arranging the bead spacers at fixed points in the BM portion (Black Matrix portion) that is located between the pixel portions and do not affect the display quality by using an ink jet method or a printing method.

Usually there is a case where the temperature of the liquid crystal display panel itself reaches as high as 50-60° C. due to a working environment and by an effect of heating of a backlight etc. during its operation. Generally the volume of a liquid crystal material used in the liquid crystal display panel increases by approximately 2-3% by a temperature rise of 30° C. As one example, assuming that the temperature of the liquid crystal panel with a cell gap of 5 μm rises by 30° C. and the volume thereof increases by 2%, the cell gap will become wider by 0.1 μm.

In the ordinary liquid crystal display panel, even when volume expansion of the liquid crystal occurs due to a temperature change in a working environment and a temperature rise of the panel by its backlight, the thickness over the whole plane of the panel must be uniform by a function of the spacer. Therefore, it is common that, considering a portion of volume expansion of the liquid crystal due to this temperature change at the time of manufacture of the liquid display panel, the assembly is so performed that the spacers are in a state of elastic deformation as shown in FIG. 8.

FIG. 8 is a partial sectional view of a liquid crystal display panel in the case where bead spacers or photo-spacers are used. FIGS. 8A and 8B show a state when the photo-spacers are arranged at fixed points on the CF substrate, and FIGS. 8A and 8B show a state when the photo-spacers are directly formed on the CF substrate by using a photolithography process.

In the case where the bead spacers are used, for example, in the case of manufacturing a liquid crystal display panel with a target cell gap of 5 μm, the bead spacers of a diameter of 5 μm shown in FIG. 8A will be used. However, in the case where the photo-spacers 4 shown in FIG. 8C are used as the spacer for determining the cell gap, it is necessary to form the photo-spacer such that the diameter (D) thereof is larger than the height thereof as shown in FIG. 8D in order to form a stable shape in a photolithography process. FIG. 8C shows a case where the diameter of this photo-spacer is made five times as larger as the diameter of the bead spacer (in order to compare the dimensions, five bead spacers are virtually shown in this figure by dotted lines to display the dimensions).

As shown in FIG. 8B, in the case of the bead spacer 3, after assembly of the liquid crystal display panel, the bead spacer 3 comes into a state where its height apparently reduced to hb in comparison with an original diameter HB indicated by the dotted line, due to deformation of the bead spacer 3 or sinking of the bead spacer 3 into a film of an alignment film etc. on the substrate surface. This shows that the assembly is made with the bead spacer 3 being deformed by amount HB-hb, as indicated by the solid line. Incidentally, FIG. 8B shows a case where the panel is assembled with the bead spacer 3 being deformed.

Similarly, in the case of the photo-spacer 4 shown in FIGS. 8C, 8D, the height of the photo-spacer 4 becomes hf after assembly of the liquid crystal display panel as compared with the original height HF of the photo-spacer, and the panel is assembled with the photo-spacer 4 being deformed by amount HF-hf. These values must be equal to or more than a variation of cell gap against the temperature change described above.

FIG. 9 is a conceptual diagram of a relation between a load applied to a columnar spacer and a single bead spacer (the bead spacer being used in the singular) and deformation amounts corresponding to these (hereinafter referred to as a load-displacement characteristic). As an example, a columnar spacer that is made by using an ultraviolet (UV)/heat curing type resist material as the photo-spacer 4 of diameter (D): approximately 30 μm and height (HF) : approximately 5 μm, as shown in FIGS. 8C, 8D, will be explained.

The load-displacement characteristic of this photo-spacer 4 will be the one shown by a curve designated by A in FIG. 9. In a steady state, the spacer must be deformed by such a degree that the deformation amount is larger than a variation of cell gap caused by the temperature change of the liquid crystal display panel described above. This corresponds to an area designated by F in FIG. 9. Therefore, when a reaction force of the spacer is not more than the lower limit of the area designated by C in FIG. 9, a defect by the temperature change described above will occur. Moreover, in the case where the liquid crystal display panel is assembled when the reaction force of the spacer is equal or more than the upper limit of the area designated by C in FIG. 9, another defect that will not be described in details will occur. Therefore, it is very important to control the reaction force of the spacer after assembly of the liquid crystal display panel to be within a predetermined range (the area designated by C in FIG. 9).

In the case where the liquid crystal display panel is manufactured using a photo-spacer with a characteristic indicated by the curve designated by C in FIG. 9 while controlling a load applied to this in an appropriate range (the area designated by C in FIG. 9), since the tolerance of the deformation amount of the photo-spacer (the area designated by Din FIG. 9) is small, a manufacture margin of the liquid crystal display panel (product) becomes also small. Therefore, it can also be said that this photo-spacer is a material that makes it hard to manufacture the liquid crystal display panel therewith.

On the other hand, bead spacers include the silica spacer whose material is a glass and the bead spacer made of a polymeric material. Since it is the silica spacer is made of a glass material, its compressive elasticity modulus (or, compressive modulus, hereinafter referred to as compressive elasticity modulus) is approximately 4-6 Ns/mm², which is larger than the compressive elasticity modulus of the bead spacer made of polymeric material, approximately 0.5 N/mm². Thus, since the silica spacer is a material harder than the bead spacers made of polymeric materials, it is unsuitable as a spacer compatible to volume expansion of the liquid crystal material due to the temperature change described above.

On the other hand, the characteristic of the bead spacer made of polymeric material is a load-displacement characteristic of the single bead spacer as designated by the curve B in FIG. 9, indicating that even with a smaller change of the load thereto results in a larger deformation amount thereof. Accordingly, when the liquid crystal display panel is manufactured using a bead spacer made of polymeric material with a load given to this being controlled in a proper range (the area designated by C′ in FIG. 9′), a tolerance of the deformation amount of the bead spacer (the area designated by E in FIG. 9) is larger than that of the photo-spacer, and therefore the manufacture margin of the liquid crystal display panel (product) will become large. Therefore, it can be said that a bead spacer made of polymeric material is a material with which a liquid crystal display panel becomes easy to fabricate.

However, the bead apace made of polymeric material has a larger deformation amount against a change of load applied to the single spacer than the photo-spacer, but has a smaller compression rupture strength. When the load applied to the bead spacer exceeds a proper range C′, the bead spacer itself will be susceptible to rupture. Moreover, when the load applied to the bead spacer is below a proper range C′, a range F′ of the deformation amount affected by the temperature change is as large as swallows a tolerance D of the deformation amount of the photo-spacer. If, in order to solve the former problem, an arrangement density of the bead spacer in the liquid crystal display panel is increased, the load-displacement characteristic shifts to the curve B′ from the curve B in FIG. 9, approaching to the load-displacement characteristic (curve A) of the photo-spacer. Therefore, the bead spacer becomes hard to rapture even when the load applied on the bead spacer exceeds an appropriate range C′, but on the other hand a range of allowable deformation amount for the bead spacer becomes narrower. From the circumstances above, it is desirable that spacers for liquid crystal display panels possess features that will be discussed below.

FIG. 10 is a conceptual diagram of a load-displacement characteristic (or, a load-deformation amount characteristic) of an ideal spacer for the liquid crystal display panel. The spacer exhibiting the load-displacement characteristic shown in FIG. 10 has a small deformation amount as compared with the reaction force B. For this reason, against an external fore applied to the liquid crystal display panel when the liquid crystal display panel is installed in a bezel or a case of a frame, when it is transported, and when it is built into a television device etc. and used, the spacer installed in it has a proof strength that validates the capability of being strong enough not to rupture and suppresses a change of the cell gap of the liquid crystal display panel.

Moreover, in the above case, a range of deformation amount of the spacer to which a load within an appropriate range (from a lower limit A to an upper limit E) is applied is controlled to be wide, and a variation of reaction force of the spacer is controlled to be small with respect to a wide variation range C of deformation amount of the spacer. Furthermore, since the deformation amount D against a large load does not increase so much, plastic deformation of the spacer is small or close to non-existent. Because of these properties, a spacer having the load-displacement characteristic shown in FIG. 10 is considered “ideal.”

When the liquid crystal display panel is assembled, the spacer has a minimum reaction force. The deformation amount of the spacer at this time must be larger than a variation of cell gap caused by the temperature change of the liquid crystal display panel (A in FIG. 10).

The spacer has a proof strength that validates the capability of being strong enough not to rupture and allow the cell gap to change even if being subjected to an external force when the liquid crystal display panel is fixed into the frame etc. or an external force at the time of being transported and used (B in FIG. 10). Moreover, even if the deformation amount of the spacer changes, the load shows little variation and the deformation amount for such a change is wide (C in FIG. 10). Further, there is no plastic deformation, or if any the deformation amount is small (D in FIG. 10).

Ordinarily in manufacturing the liquid crystal display panel, a range other than a range of incapability as a panel even when there occurs volume expansion due to the temperature change described above (a proper load range in FIG. 10) is set, and the liquid crystal display panel is so manufactured that the characteristic of the spacer falls within that range. When assembling the liquid crystal display panel using a spacer with a characteristic as shown in FIG. 10, a pressure applied between the substrates and the amount of liquid crystal injected in-between are so adjusted that the deformation amount of the spacer falls in the center of the range designated by C in FIG. 10.

It can be said that, in the case where the range designated by C in FIG. 10 is wide, even if there is a manufacture variation, the volume expansion of the liquid crystal display due to the temperature change does not cause the display quality of the liquid crystal to vary provided that the cell gap is within a range of tolerance. However, the photo-spacer and the bead spacer currently used exhibit load-displacement characteristics as shown in FIG. 9, which are quite different from the ideal characteristic.

Several documents on the conventional techniques may be enumerated as follows: JP 7-270805 A discloses the conventional technique considering deformation of the bead, JP 61-173222 A and U.S. Pat. No. 5,963,288 discloses a technique of using a photo-spacer for determining a cell gap between a pair of substrates, and JP 2002-182220 A discloses a technique considering substrate shift when the photo-spacer is used.

[Patent document 1] JP 7-270805 A

[Patent document 2] JP 61-173222 A

[Patent document 3] U.S. Pat. No. 5,963,288

[Patent document 4] JP 2002-182220 A

### SUMMARY OF THE INVENTION

The conventional liquid crystal display panel is manufactured, in order to set a layer thickness of a liquid crystal injected between one pair of substrates to a predetermined value, by a method of dispersing spherical bead spacers on the whole surface of the substrate or arranging them using an ink jet method or a printing method at fixed points in a portion that is located between pixel portions and does not affect display quality, and determining a cell gap by the bead spacers. Moreover, there is used a method of making columnar spacers (photo-spacers) beforehand by a photolithography method using a photosensitive resign for a portion that is located between pixel portions on a substrate and does not affect the display quality, and the like.

When an external force is applied to the liquid crystal display panel manufactured using this kind of spacer, the spacer exhibits elastic deformation and the cell gap changes. If the cell gap changes, display unevenness occurs at that portion, but if the external force is removed, the cell gap recovers its original geometry by the reaction force of the spacer. Thus, any spacer used in the liquid crystal display panel is required to have tolerability meaning that the spacer would not rupture (nor yield plastic deformation) in the presence of an external force. The tolerability of a spacer suitable for the liquid crystal display panel has been determined. In order to increase this tolerability, in the case of using a bead spacer, it is necessary to increase the arrangement density of the bead spacer. In the case of using the photo-spacer, it is necessary to use a resist material with a high compressive elasticity modulus, increase the diameter of the photo-spacer, or increase the arrangement density thereof.

However, in the case where the liquid crystal display panel with an appropriate range of load designated by C in FIG. 9 and in FIG. 10 (an appropriate range of reaction force of the spacer) is tried to be manufactured using a spacer with increased tolerability against an external force in this way, the tolerance of deformation amount of the spacer is narrow and the panel will become a product severe in manufacturing precision, thereby becoming a difficult product to manufacture.

In view of this, the object of this invention is to provide a liquid crystal display panel that has high tolerability when an external force is applied to the liquid crystal display panel and a wide range of deformation amount of the spacer within a proper load range, and accordingly a liquid crystal display panel easy to manufacture, in other words, a liquid crystal display panel having a wide manufacturing margin for non-defective product.

An outline of typical means of this invention for attaining the above-mentioned object is as follows.

[Means 1]

Two kinds of bead spacers whose compressive elasticity moduli are different from each other are used as spacers of the liquid crystal display panel.

[Means 2]

Among the two kinds of bead spacers described in the means 1, the bead spacer with a small compressive elasticity modulus (the first bead spacer) is specified to have a larger diameter D1 than the diameter D2 of the bead spacer with a large compressive elasticity modulus (the second bead spacer exhibiting a larger compressive elasticity modulus than the first bead spacer) (D1>D2).

[Means 3]

When the assembly of the liquid crystal display panel is completed, the bead spacer with a larger compressive elasticity modulus (the above-mentioned first bead spacer) is set in a sate of elastic deformation, while the bead spacer with a larger compressive elasticity modulus (the above-mentioned second bead spacer) is set in a state of no deformation or a state where its elastic deformation amount is smaller than that of the bead spacer with a smaller compressive elasticity modulus. The compressive elasticity modulus described in this specification is defined including the elastic modulus in a static state (state where a time-varying force is not applied) that is known as the Young's modulus, and the complex shear elasticity modulus in a dynamic state. The compressive elasticity modulus of a material signifies a force applied to a unit area of the material required to compress the material until the thickness thereof becomes zero, and the larger this value, the harder the material is. With the means 3, for example, a group of the bead spacers with a smaller compressive elasticity modulus undergoes larger elastic deformation than the other group of the bead spacers with a larger compressive elasticity modulus than that of the one group, in a space between a pair of substrates constituting the liquid crystal display panel.

[Means 4]

Two kinds of spacers of a bead spacer and a photo-spacer are used as spacers of the liquid crystal display panel.

[Means 5]

The photo-spacer among the bead spacer and the photo-spacer described in the means 4 is specified to have a shape or the arrangement density that satisfies the tolerability against an external force and the diameter D of the bead spacer is specified to be larger than the height H of the photo-spacer (D>H).

By this invention, even if an external force when the liquid crystal display panel is installed to a frame etc. of the liquid crystal display device and an external force when in being transported, being used, etc. are applied to the liquid crystal display panel, there does not occur rupture (nor plastic deformation) of the spacer and a change in the cell gap that may result in a defect. In addition, since this invention widens a range of deformation amount of the spacer to secure the reaction force of the spacer that dose not cause a defect as the liquid crystal display panel, it becomes possible to manufacture a high-quality liquid crystal display panel at a high yield.

### BRIEF DESCRIPTION OF THE DRAWINGS

FIGS. 1A, 1B, and 1C are explanatory diagrams of a first embodiment of this invention;

FIG. 2 is a conceptual diagram of a load-displacement characteristic (or, a load-deformation amount characteristic) of a spacer in the first embodiment of this invention;

FIGS. 3A, 3B, 3C, 3D, and 3F are explanatory diagrams of an example of a liquid crystal injection process by the drop injection scheme (known as “one drop filling method”);

FIG. 4 is a conceptual diagram of a load-displacement characteristic of a spacer in a second embodiment of this invention;

FIGS. 5A, 5B are explanatory diagrams of a third embodiment of this invention;

FIGS. 6A, 6B are explanatory diagrams of a configuration of the conventional liquid crystal display panel using a bead spacer;

FIGS. 7A, 7B are explanatory diagrams of a configuration of the conventional liquid crystal display panel using a columnar spacer;

FIGS. 8A, 8B, 8C, and 8D are partial sectional views of the liquid crystal display panel using the bead spacer or a photo-spacer;

FIG. 9 is a conceptual diagram of the load-displacement characteristics of a single columnar spacer and of a single bead spacer, respectively; and

FIG. 10 is a conceptual diagram of a load-displacement characteristic of an ideal spacer as that for liquid crystal display panel.

### DETAILED DESCRIPTION OF THE PREFERRED EMBODIMENTS

Hereafter, best modes of carrying out this invention will be described more specifically by embodiments.

### First Embodiment

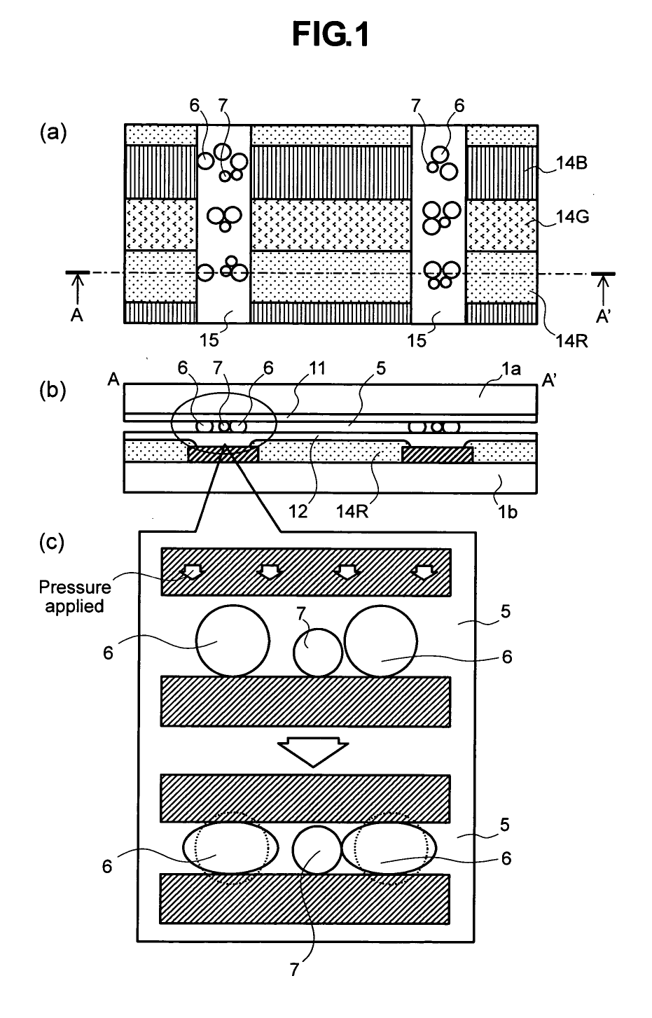

FIGS. 1A-1C are explanatory diagrams of a first embodiment of this invention. FIG. 1A is an inner plan view of a CF substrate side, FIG. 1B is a sectional view of FIG. 1A taken along the line A-A′ (a cross section of a CF substrate 1b with which a TFT substrate 1a is overlapped) and FIG. 1C is a schematic view of an enlarged principal part of FIG. 1B. In FIG. 1C, a pair of hatched rectangles that sandwiches spacers 6, 7 indicates the TFT substrate 1a and a construction formed on its principal plane (the above-mentioned TFT layer 11 etc.), and the CF substrate 1b and a construction formed on its principal plane (the above-mentioned resin layer 12 etc.), respectively. In FIG. 1C, the upper part shows a liquid crystal display panel before pressurization, and the lower part shows shapes of the spacers 6, 7 in the liquid crystal display panel after pressurization, respectively. The first embodiment is characterized by the use of two kinds of bead spacers having different compressive elasticity moduli as spacers for maintaining a constant gap between the TFT substrate and the CF substrate that make a pair of substrates.

The bead spacers are individual components on both the TFT substrate and the CF substrate. In the first embodiment, the bead spacer 7 of silica whose compressive elasticity modulus is larger is used as one of the two kinds of bead spacers, and the bead spacer 6 made of polymeric material whose compressive elasticity modulus is smaller than that of the one is used as the other bead spacer. Furthermore, the diameter of the bead spacer 6 made of polymeric material is made larger than the diameter of the bead spacer 7 of silica.

The two kinds of bead spacers 6, 7 that differ from each other in compressive elasticity modulus are arranged at fixed points in a shading layer portion (Black Matrix portion: BM portion) 15 that is a non-display area located between the pixel portions and not affecting the display quality. The liquid crystal display panel is assembled using the TFT substrate la and the CF substrate 1b in which two kinds of bead spacers 6, 7 are arranged. FIG. 1 shows the pixel portion as the color filters (CF's) 14R, 14G, and 14B that are different from one another in color, and the non-display areas are shown as the plurality of shading layer portions 15 that separate pixel columns in which these color filters 14R, 14G, and 14B are arranged repeatedly. Definition of the pixel portion is not limited to definition by the color filters 14R, 14G, and 14B, but the pixel portion may be defined using pixel electrodes of a TFT type liquid crystal display device. The non-display area is provided as one shading layer portion in which an opening is formed correspondingly to a plurality of pixel portions. The non-display area discussed in this patent specification is located in a display area consisting of a plurality of pixels arranged on a plane of the liquid crystal display panel, and forms a dark space between the pair of substrates 1a, 1b where it is difficult for light to transmit.

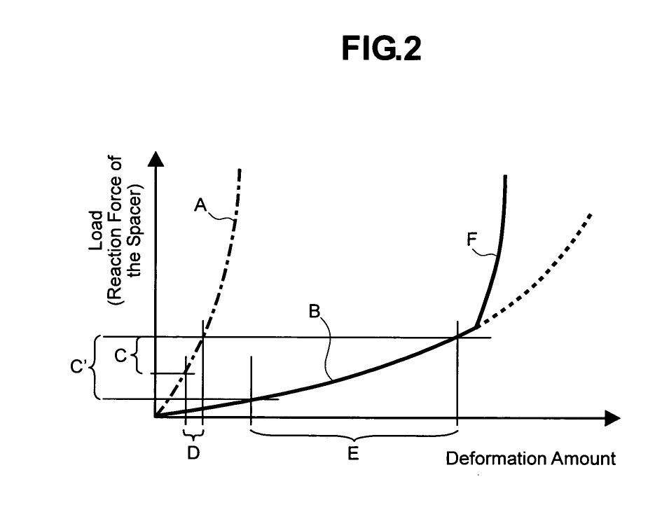

FIG. 2 is a conceptual diagram of a load-displacement characteristic (or, a load-deformation amount characteristic) of a spacer in a first embodiment of this invention. In the liquid crystal display panel of the first embodiment, as shown in FIGS. 1B and 1C, only the bead spacer 6 made of polymeric material with a large diameter is deformed in a normal state. Thus, the load-deformation characteristic of a composite spacer consisting of two kinds of bead spacers is as shown in FIG. 2. There will occur a display defect in the liquid crystal display panel after the assembly is completed when the reaction force of the spacer is not more than a range designated by C in FIG. 2 or when the reaction force is not less than the range. Therefore, assembly conditions shown below must be so adjusted that the reaction force falls within this range.

As the method for injecting liquid crystal in manufacture of the liquid crystal display panel using the CF substrate, there are proposed two schemes as a rough classification: a vacuum injection scheme, and a dropping injection scheme. The vacuum injection scheme is a scheme in which the TFT substrate and the CF substrate are overlapped with each other and fixed (a sticking process of the two substrates), and subsequently the liquid crystal is injected in a space between the TFT substrate and the CF substrate that is secured by the spacers.

When manufacturing the liquid crystal display panel by the liquid crystal injection method based on the vacuum injection method, first, an empty liquid crystal display panel with no liquid crystal is prepared by overlapping the TFT substrate and the CF substrate and securing the cell gap between the substrates by the spacers. Then, the liquid crystal is injected from a liquid crystal inlet provided on a part of the liquid crystal display panel using capillarity and a pressure difference. In this liquid crystal injection method using a pressure difference between an empty liquid crystal display panel (also written simply as panel) and an ambient atmosphere, after gap adjustment between the substrates by the sticking step of sticking the substrates being overlapped with each other is completed, an internal space of the empty liquid crystal display panel is evacuated and the pressure of the internal space is reduced.

After that, the liquid crystal inlet provided on a part of surrounding of the panel made by sticking the substrates is contacted to the liquid crystal and the surrounding of the panel is set back to the atmospheric pressure or given an increased pressure, whereby the liquid crystal is injected into the inside of the panel (liquid crystal display panel) using a pressure difference between the inside and the outside of this panel. Then, surplus liquid crystal is discharged by applying a force to the whole liquid crystal display panel (panel after injection of the liquid crystal), the deformation amount of the bead spacer is set to a predetermined value, and the liquid crystal inlet is sealed with a sealant, such as of ultra violet curing type, in order to maintain this state.

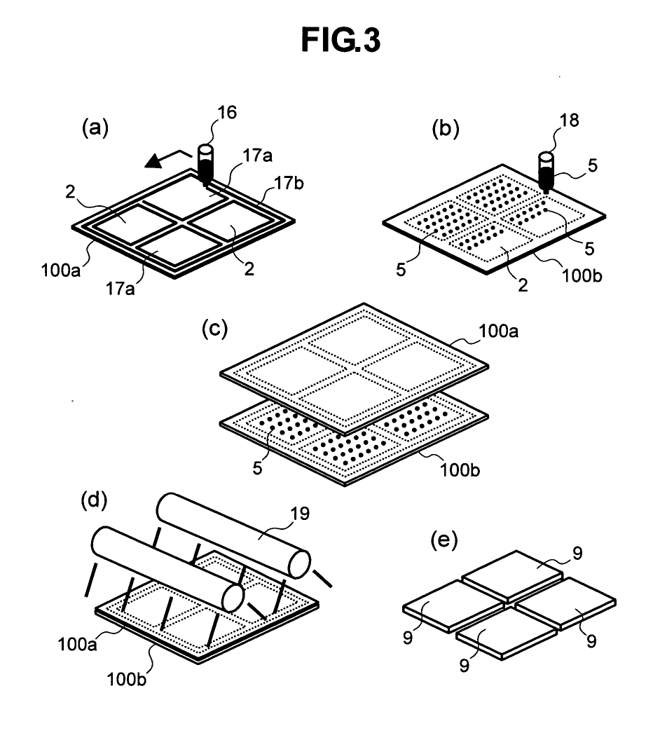

FIG. 3 is an explanatory diagram of an example of a liquid crystal injection process by a dropping injection method. The dropping and injection method is a method of simultaneously performing the assembly of the liquid crystal display panel whereby a pair of substrates is stuck together after the liquid crystal was dipped on either of the pair of substrates (the TFT substrate and the CF substrate) and the injection of the liquid crystal in-between. In this embodiment, the method will be explained provided that mother substrates (e.g. mother glass) for providing two or more liquid crystal display panels are used to obtain liquid crystal display panels each with the TFT substrate and the CF substrate. That is, as shown in FIG. 3A, a sealant 17a is coated on either of a mother substrate 100a for TFT substrate or a mother substrate for the CF substrate 100b (in the embodiment, the mother substrate for the TFT substrate 100a is assumed) using a dispenser 16 so as to surround each of the regions 2 that will become individual liquid crystal panels, and a sealant 17b is also coated on the periphery of the mother substrate for the TFT substrate 100a.

Next, as shown in FIG. 3B, the liquid crystal is dipped by a specified amount on each of the regions 2 that will be individual liquid crystal panels of the mother substrate for the CF substrate 100b using a dispenser 18. The mother substrate for the TFT substrate 100a is over lapped with the mother substrate for the CF substrate 100b on which liquid crystal 5 was dipped in a vacuum atmosphere. At this time, as shown in FIG. 3C, the principal plane of the mother substrate for the TFT substrate 100a, namely a plane on which the sealants 17a, 17b are coated, is stuck to the principal plane of the mother substrate for the CF substrate 100b, face to face.

Then a gap between the mother substrate 100a for the TFT substrate 100a and the mother substrate for the CF substrate 100b is adjusted (cell gap adjustment), the sealants 17a, 17b are cured by irradiating them with curing light 19 for curing a sealant such as an ultraviolet light source, fixing the pair of substrates (FIG. 3D). Then, the pair of substrates is separated into individual liquid crystal display panels 9 (FIG. 3E). Thus, injection of the liquid crystal and assembly are performed simultaneously.

In the case of this method, in order to adjust the deformation amount of the bead spacer to a predetermined value, it is necessary to calculate a total amount of the liquid crystal to be sealed from the predetermined value of the gap between the TFT substrate and the CF substrate overlapped with each other and drop the total amount accurately on the TFT substrate or the CF substrate before sticking the substrates. In such a manufacturing method, in order to set the reaction force of the spacer of the liquid crystal display panel to a predetermined range (a range designated by C in FIG. 2), a wider range of deformation amount of the spacer is desirable. The wider range also facilitates manufacture of the liquid crystal display panel. Therefore, according to the first embodiment, while the tolerability against an external force does not change from the conventional panel, a margin for manufacturing the products is widened.

### Second Embodiment

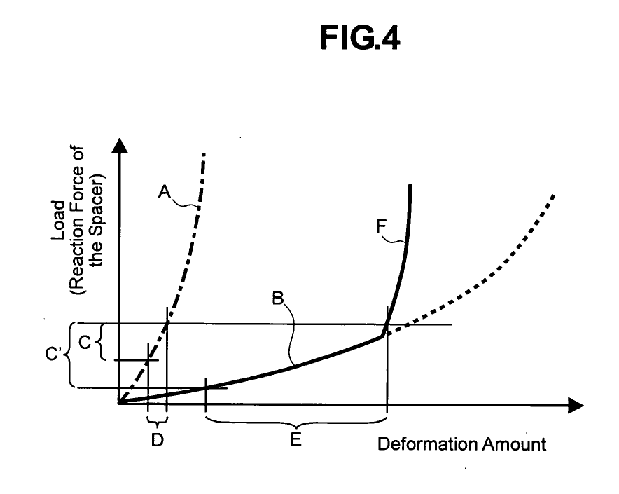

FIG. 4 is a conceptual diagram of a relation between a load applied to the spacer in a second embodiment of this invention and the deformation amount thereof (load-displacement characteristic). The second embodiment makes it possible to improve the tolerability against an external force while maintaining the performance of the liquid crystal display panel as it was in the normal state by increasing an arrangement density of the bead spacer 7 of silica of the liquid crystal display panel that has the bead spacer and the panel configuration explained in the first embodiment.

The liquid crystal display panel of the first embodiment is assembled usually, as shown in FIGS. 1A and 1B, in a sate in which the bead spacer of silica is not applied pressure by the TFT substrate 1a and the CF substrate 1b. However, even if the bead spacer 7 of silica is applied pressure a little by the TFT substrate 1a and the CF substrate 1b and deforms in the liquid crystal display panel in the normal state, but if being under a condition that the diameter of the bead spacer 6 made of polymeric material is larger than the diameter of the bead spacer 7 of silica, a (virtual) spacer obtained by a combination of them exhibits a load-displacement characteristic as shown in FIG. 4. As is clear from comparison between FIG. 2 and FIG. 4, since a range of deformation amount allowed to the (virtual) spacer (the area designated by E) in this embodiment is narrower than that of the first embodiment, a manufacture margin of the liquid crystal display panel using this is low as compared with the liquid crystal display panel of the first embodiment that is assembled without deforming the bead spacer 7 of silica. However, as compared with the conventional liquid crystal display panel assembled using only the photo-spacer or the bead spacer, the manufacture margin of the liquid crystal display panel of this embodiment is wide.

### Third Embodiment

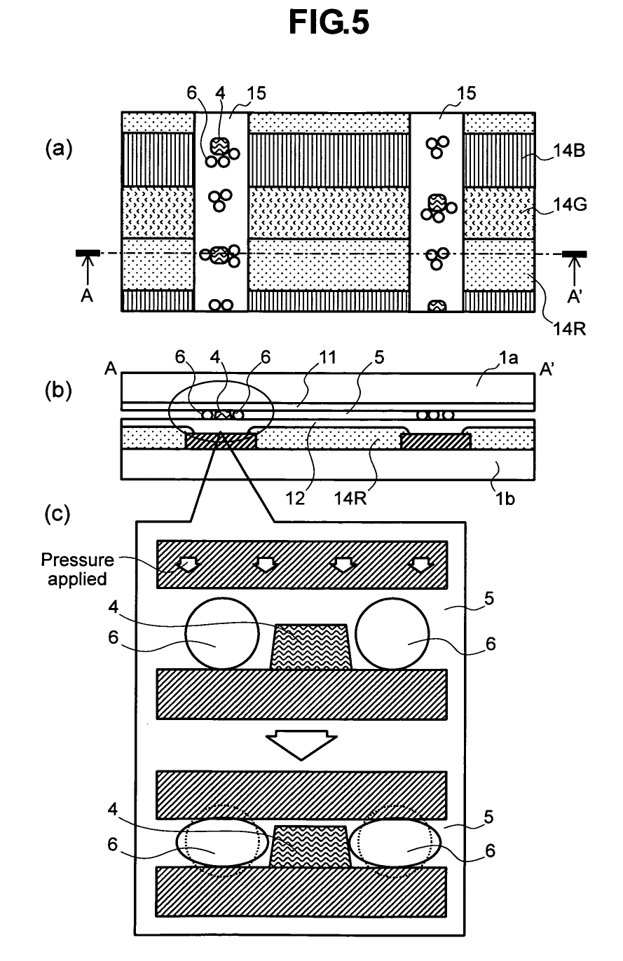

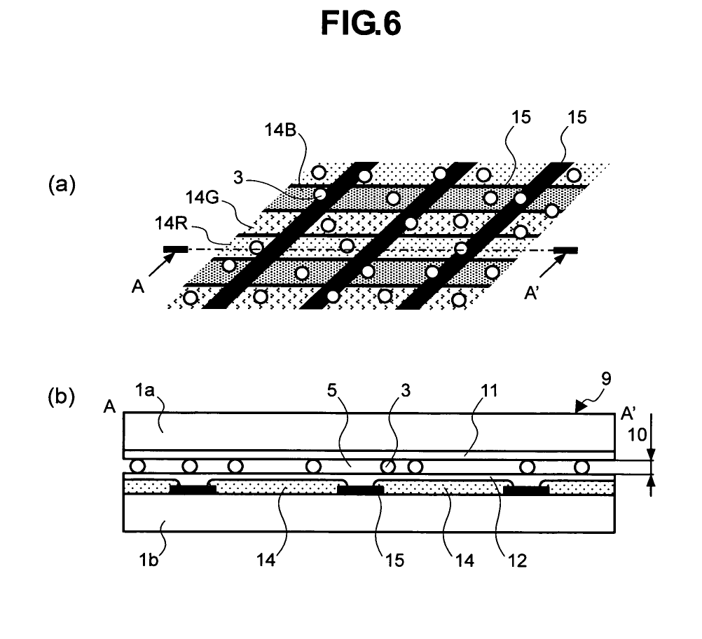

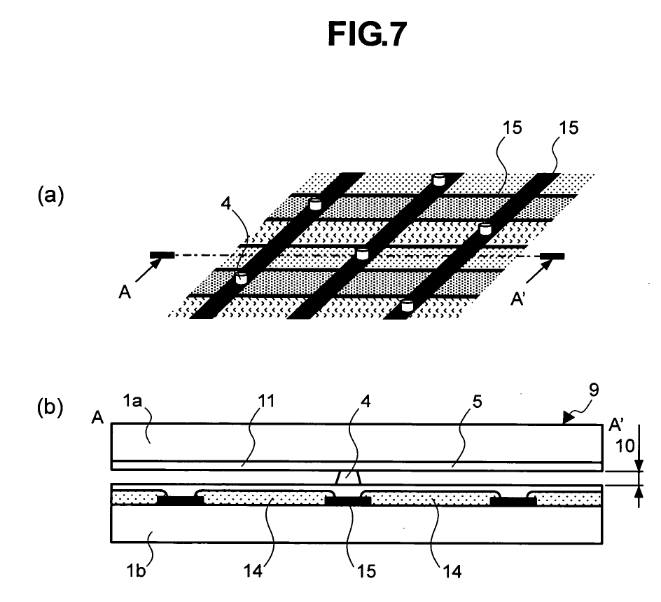

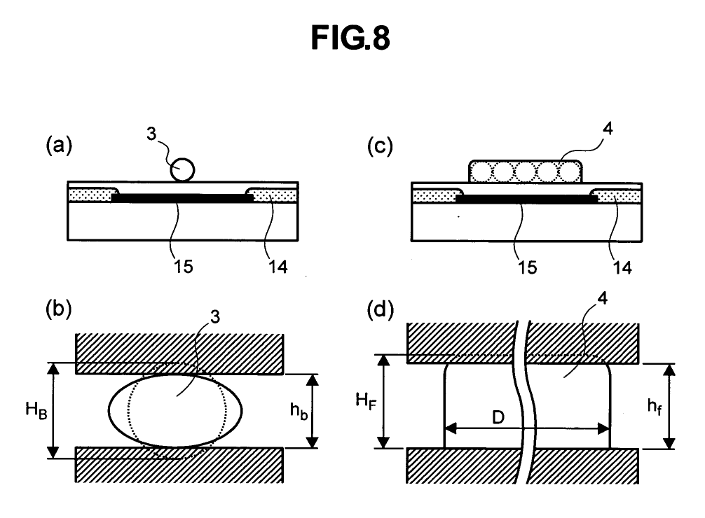

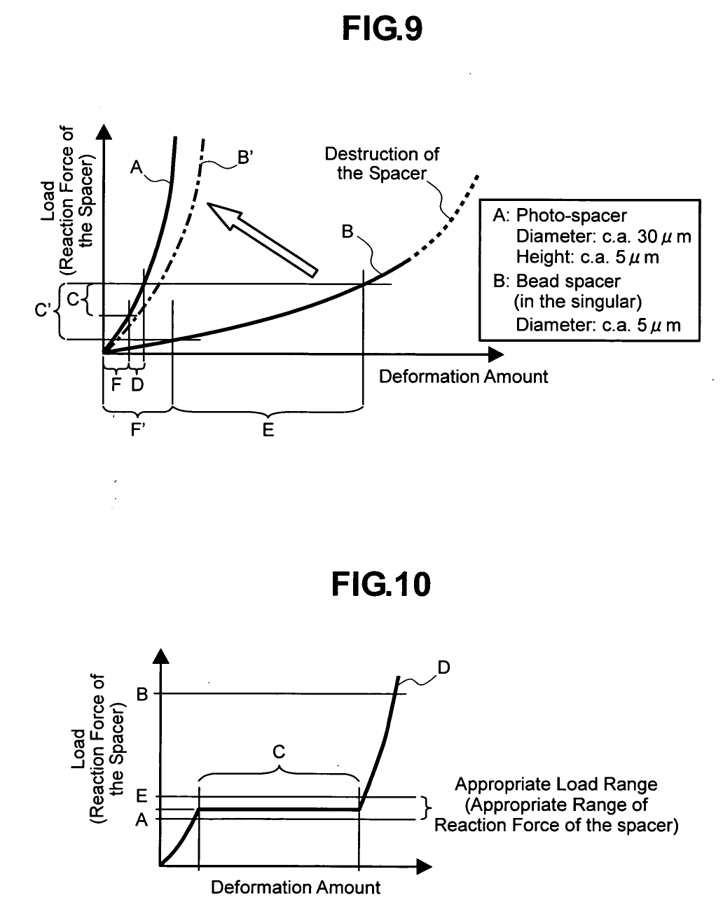

FIGS. 5A, 5B, and 5C are explanatory diagrams of a third embodiment of this invention. FIG. 5A is an inner plan view of the CF substrate; FIG. 5B is a sectional view of FIG. 5A taken along the line A-A′ (a cross section of the CF substrate 1b with which the TFT substrate 1a is overlapped; and FIG. 5C is a schematic view of an enlarged principal part of FIG. 5B. In FIG. 5C, a pair of hatched rectangles sandwiching the spacers 4, 6 represents the TFT substrate 1a and a structure formed on its principal plane (the above-mentioned TFT layer 11 etc.), and the CF substrate 1b and a structure formed on its principal plane (the resin layer 12 etc.), respectively. Moreover, the upper part and the lower part of FIG. 5C show a liquid crystal display panel before pressurization and shapes of the spacers 4, 6 in the liquid crystal display panel after pressurization, respectively. In the third embodiment, the photo-spacer 4 formed by a photolithography method and the bead spacer 6 made of polymeric material are used as spacers for maintaining a constant gap between the TFT substrate 1a and the CF substrate 1b. The photo-spacer 4 is formed being integral with the CF substrate 1b by coating a photosensitive polymeric resin on the uppermost surface of the principal plane of the CF substrate 1b and exposing this through a mask.

The photo-spacers 4 are controlled in shapes thereof and arrangement density thereof in the BM portion as a non-display region separating a plurality pixel portions from one another so that the photo-spacer 4 itself will not enter either a rupture range thereof or a plastic deformation range thereof even if a specific external force is applied to the liquid crystal display panel. In addition, the bead spacer whose outside shape (diameter) is larger than the height of the photo-spacer 4 is arranged at fixed points in the BM portion of the CF substrate 1b similarly, and finally the TFT substrate 1a is stuck to this CF substrate 1b to assemble the liquid crystal display panel.

In the normal state of the liquid crystal display panel of the third embodiment, only the bead spacer 6 made of polymeric material is deformed from a shape before pressurization indicated by the dotted line shown in FIG. 5C to a shape after pressurization indicated by the solid line. Thus, a load-displacement characteristic of the case where the photo-spacer 4 having a changed height and the bead spacer 6 made of polymeric material is used becomes as shown in FIG. 2.

Since there will occur a display defect in the liquid crystal display panel when the value of reaction force of the spacer after its assembly is completed is not more than a range designated by C in FIG. 2 or when the value of reaction force is not less than the range, the assembly conditions must be so adjusted that the reaction force of the spacer falls within the range. Since the third embodiment enlarges the tolerance of the deformation amount of the spacer while the tolerability of the spacer against the external force remains the same as the conventional liquid crystal display panel, it becomes possible to provide a liquid crystal display panel with a wide manufacture margin and thereby easy-to-manufacture panel consequentially.

### Fourth Embodiment

A fourth embodiment is a liquid crystal display panel with a panel configuration of the photo-spacer and the bead spacer explained in the third embodiment such that a shape of the photo-spacer 4 is made larger or its arrangement density is increased with the same height of the photo-spacer 4, whereby performance of the liquid crystal display panel in the normal state is maintained as high as that of the third embodiment and its tolerability against an external force is improved. For example, an area of the photo-spacer 4 in the principal plane of the CF substrate 1b before being assembled with the TFT substrate 1a is set larger than an area of the bead spacer 6 before deformation; alternatively, the additional photo-spacer 4 that dose not adjoin the bead spacer in the principal plane of the CF substrate 1b shown in FIG. 5A is formed above the shading layer portion 15. Moreover, the liquid crystal display panel of the third embodiment was assembled in such a way that in its normal state, the photo-spacer 4 was pressurized neither by the TFT substrate 1a nor by the CF substrate 1b, as shown in FIGS. 3B, 3C. On the other hand, in the liquid crystal display panel of this embodiment, even when the photo-spacer 4 contacts the TFT substrate 1a and is pressurized a little to effect deformation in its normal state, if the photo-spacer 4 satisfies a condition that its height is smaller than the diameter of the bead spacer 6 made of polymeric material before pressurization, a (virtual) spacer that is realized by combining the photo-spacer 4 and the bead spacer 6 exhibits a load-displacement characteristic as shown in FIG. 4. Therefore, although the manufacture margin of the liquid crystal display panel of this embodiment is narrower than that of the liquid crystal display panel assembled in the state where the photo-spacer 4 is not deformed, but it is wider than the manufacture margin of the liquid crystal display panel assembled only using the photo-spacer or the bead spacer.

According to each embodiment of this invention, as described in the foregoing, there can be provided a liquid crystal display panel whose manufacture margin is widened without impairing tolerability of the liquid crystal display panel against an external force.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A liquid crystal display panel comprising: a pair of substrates;
liquid crystal interposed between the one pair of substrates; and
a plurality of pixels formed on one of the one pair of substrates; wherein
two kinds of bead spacers independent from the pair of substrates are arranged in at least one of non-display areas located between the plurality of pixels in the liquid crystal display panel,
the two kinds of bead spacers have mutually different compressive elasticity moduli, and
the pair of substrates are spaced from each other by a predetermined gap by the two kinds of spacers.

2. The liquid crystal display panel according to claim 1, wherein
the diameter of the bead spacer with a small compressive elasticity modulus among the two kinds of bead spacers is larger than the diameter of the bead spacer with a large compressive elasticity modulus.

3. The liquid crystal display panel according to claim 1, wherein
in a state of completion of assembly of the liquid crystal display panel, the bead spacer with a small compressive elasticity modulus is undergoing elastic deformation, while the bead spacer with a large compressive elasticity modulus is not undergoing elastic deformation.

4. The liquid crystal display panel according to claim 1, wherein
in a state of completion of assembly of the liquid crystal display panel, deformation amount of the bead spacer with a small compressive elasticity modulus is larger than deformation amount of the bead spacer with a large compressive elasticity modulus.

5. A liquid crystal display panel comprising:
a first substrate;
a second substrate;
liquid crystal interposed between the first substrate and the second substrate; and
a plurality of pixels formed on the first substrate; wherein
a photo-spacer formed on one of the first and second substrates being integral therewith directly by a photolithography method and a bead spacer that is independent from the first and second substrates are arranged in at least one of non-display areas located between the plurality of pixels in the liquid crystal display panel, and
the first and second substrates are spaced from each other by a predetermined gap by the photo-spacer and the bead spacer.

6. The liquid crystal display panel according to claim 5, wherein
the height of the photo-spacer in the gap direction of the first and second substrates is smaller than the diameter of the bead spacer.

7. The liquid crystal display panel according to claim 5, wherein
in a state of completion of assembly of the liquid crystal display panel, the bead spacer is undergoing elastic deformation and the photo-spacer is not undergoing elastic deformation.

8. The liquid crystal display panel according to claim 5, wherein
in a state of completion of assembly of the liquid crystal display panel, deformation amount of the bead spacer is larger than deformation amount of the photo-spacer.
